(19) United States
(12) Patent Application Publication
(10) Pub. No.: US 2020/0312185 A1
(43) Pub. Date: Oct. 1, 2020

(54) ATTACHABLE AND DETACHABLE PADDED AND OR INFLATABLE POTTY PAD CUSHION SYSTEM

(71) Applicant: Irina Shekhtman, San Diego, CA (US)

(72) Inventor: Irina Shekhtman, San Diego, CA (US)

(21) Appl. No.: 16/364,849

(22) Filed: Mar. 26, 2019

(51) Int. Cl. G09B 19/00; A47K 17/02

(52) U.S. Cl. CPC G09B 19/0076; F16B 47/003; A47K 17/028

(57) ABSTRACT

This application relates to a system and methods for the educating, inspiring, encouraging, entertaining, engaging, and assisting of a toddler and or child to squat while defecating into a toddler-sized potty or adult-sized toilet. The system can include a cushion, padding, and or inflatable material. The system can be attached and detached to a floor and or other appropriate mounting surface without the need for tools and can be compatible with nearly any preexisting footstool. The system can emit lights, sounds, scents, and or vibration when engaged. The system can be attached and detached to a floor or any other appropriate mounting surface. The system can further include a container for the storage and or transportation of the system. The system can further serve to transport, store, and protect material objects. The system can be used independent of, or in collaboration with, the container.

### CROSS-REFERENCE TO RELATED APPLICATION

None

### FEDERALLY SPONSORED RESEARCH

None

### BACKGROUND

This application relates to a system and methods for the education, engagement, inspiration, instruction, encouragement, and assistance of, toddlers and children, in expelling bowel waste into a children's sized potty while encouraging a squatting posture. The system can include positive affirmations, instructional, and or educational material, related and or not related to the expulsion of human waste from the child's body. This system can serve to be adaptable to preexisting stools designed for adult-sized, Western and or Eastern style toilets. The system can be personalized, and designed to resemble a character, individual, mode of transportation, and or animal. The system can be attached and detached to a floor and or other mounting surface without the need for tools and can be placed in front of the child's potty to lift the child's knees into the squatting position while ensuring the child nor the system slip or move from their placement. The system can be machine and or hand washed as needed or desired. The system can further include material objects for the child to grab and or hold onto while expelling bodily waste into the potty if needed or desired. The material objects can be attached to the system and designed as a part of the character, individual, mode of transportation, and or animal. For instance, the arms, hands, tail, legs, feet, nose, eyes, mouth, ears, wings, teeth, tires, and, but not limited to, wheel. The material objects serving as a holding, pulling, and or pushing device can emit sounds, music, vibration, scents, and or, but not limited to, lighting effects when engaged. The system can include a carrying case, and or, but not limited to, a towel. The material objects and informational, educational, and affirming material can be permanent, removable, and or interchangeable.

The following is a tabulation of some prior art that presently appears relevant: U.S. Patents

| Patent Number | Kind Code | Issue Date | Patentee |
|---|---|---|---|
| 2,108,241 | A | 1938 Feb. 15 | Leta |
| 9,895,036 | B2 | 2018 Feb. 20 | Edwards et al. |
| 7,007,771 | B2 | 2006 Mar. 7 | Rawlings et al. |
| 4,713,846 | A | 1987 Dec. 22 | Hodroski, Jr. |
| 5,028,024 | A | 1991 Jul. 2 | Welles |
| 6,578,217 | B1 | 2003 Jun. 17 | Roberson |
| 6,079,067 | A | 2000 Jun. 27 | Becker et al. |
| 5,173,979 | A | 1992 Dec. 29 | Nennhaus |
| 6,925,669 | B1 | 2005 Aug. 9 | Friedman et al. |

U.S. Patent Application Publications

| Publication Nr. | Kind Code | Publ. Date | Applicant |
|---|---|---|---|
| 0263756 | A1 | 2008 Oct. 30 | Marsden |
| 0123376 | A1 | 2014 May 8 | Edwards et al. |
| 29215204 | S1 | 2003 Dec. 8 | Palazzolo |
| 0179559 | A1 | 2006 Aug. 17 | Palazzolo |
| 15212509 | A1 | 2016 Sep. 27 | Edwards et al. |
| 0255108 | A1 | 2012 Oct. 11 | Litchmore |
| 787845 | S1 | 2017 May 30 | Edwards |
| 785351 | S1 | 2017 May 2 | D'Angelo |
| 0027331 | A1 | 2017 Feb. 2 | Jensen |
| 0275355 | A1 | 2010 Apr. 30 | Bahr |
| 218784 | A1 | 2017 Dec. 21 | Edwards et al. |
| 0144725 | A1 | 2005 Jul. 7 | Guarino |
| 0189432 | A1 | 2009 Jul. 30 | Anikin |
| 801095 | S1 | 2017 Oct. 31 | Konghe |

Foreign Patent Documents

| Foreign | Cntry | Kind | Pub. | App or |
|---|---|---|---|---|
| Doc. Nr. | Code | Code | Dt | Patentee |
| 2397517 | GB | A8 | 2004 Jul. 30 | Albert et al. |

When toddlers or children are introduced into potty training they are instructed how to do so while using a child-sized potty as their bodies are far too small to meet the requirements of an adult-sized, Western or Eastern style toilet. The majority of time spent potty training is used to inform the child where to release their bodily excrements should they need to do so. Generally, into the toilet, not the diaper, their clothes, and or any other surrounding or convenient area. No prior art has given attention or consideration to encourage a healthy posture for toddlers and small children while releasing bowel movements into a child-sized potty. The habits the children develop and adopt at this phase of potty training will serve a pivotal role in the health of their bowel movement as they increase in size and into adulthood. Training the child to adhere to their natural posture while defecating, which is the squatting position, allows the child to expel and release excrement with greater ease. This further encourages a healthy colon for the child throughout their lifespan, as beginning potty training in the squatting position will allow for greater release of excrement, and reduce the likelihood of feces remaining stuck and festering inside the colon for many years to come, possibly even into adulthood. No prior art provides a comfortable place for toddlers and children to raise their legs and feet to encourage a squatting position while releasing excrement through their bowels. All prior art, even when constructed with nonslip foot placements is produced with hardened plastic or wood in an attempt to expedite cleaning if necessary. Further, no prior art provides a means for the quick and easy attachment and detachment of a cushion system that is child friendly, engaging, inspirational, and or educational. Even when prior art could be contrived to be adapted to the size of a child's potty, it is a cold, hardened, and plain device that fails to provide a comfortable and secure resting place for the child's feet, while also not allowing for the variance in size of the child's height and stance, as compared to their adult counterparts, to be taken into consideration. For instance, the desired width of their feet while resting securely on the stool.

Prior inventors have addressed some of these issues. A representative sample follows:

Several prior art inventions are known for their ability to provide children with a footstool when using a western style adult-sized toilet. For example, U.S. Pat. No. 20,080,263,756 to Marsden on Oct. 30, 2008 provides a means for a child to climb to sit on top of an adult-sized western style toilet. However, the prior art does not even address the child's needs to elevate the knees above the anus to allow for a squatting position to be achieved. Thus, easing the release of fecal matter from the body's colon.

Several prior art inventions are known for their ability to provide a footstool when using a western style adult-sized toilet. For example, U.S. Pat. No. 20,140, 123,376 to Edwards on May 8, 2014 provides a means for adults, adolescents, and even some large children, to elevate their knees while defecating on a western style, adult-sized toilet. The stool is even designed in a U-shape to allow for it to be pressed against the stem of the toilet when not in use to save space in the restroom. The footstool is also equipped with a nonslip material for the feet to rest on while in use. However, this prior art fails to provide a means for children to elevate their knees while using a child's potty. This footstool, though adjustable in height, is still geared towards the adult-sized, western style toilet. Further, this prior art requires the attachment and removal of leg extenders from the base of each foot of the footstool. However, even at its lowest variation of height, it is still dramatically too large to be used in coalition with a child's potty as it is designed to coincide with an adult-sized, western style toilet. This prior art is also preferably produced in plastic, under the assumption this is easiest to clean. Thus, it will remain bulky, cumbersome, and further limiting in its ease of transport while traveling with a toddler needing the use of a child's potty. The prior art does not provide a design that is adaptable or amicable to encouraging children to elevate their knees while sitting to use the toilet.

Several prior art inventions are known for their ability to provide children with a footstool when using a western style adult-sized toilet. For example, U.S. Pat. No. 200,329,215,204 to Palazzolo on Dec. 8, 2003 and U.S. Pat. No. 20,170,179,559 to Palazzolo on Aug. 17, 2006 provides a means for a child to climb to sit on top of, or stand above, an adult-sized western style toilet. However, this is the extent of this invention. The prior art fails to provide the child with a footstool adaptable to a child's potty.

Several prior art inventions are known for their ability to provide children with a footstool to provide an adaptable means to assist in compensating for their smaller framed bodies. For example, U.S. Pat. No. 19382108241 to Leta on Feb. 15, 1938 provides a means for adjusting the height of a child's footstool to be adaptable to even 2″ in height. However, this prior art does not provide a designated location for the child to place her or his feet. Further, this prior art is blocky and bulky, and does not provide a means to secure the footstool to the floor once the child has placed her or his feet on it. This prior art also is geared more towards children learning to play the piano. Providing a means to rest the child's feet to free up their arms to play the piano while not focusing attention and energy to balancing on the piano bench.

Several prior art inventions are known for their ability to provide an adjustable footstool when using a western style, adult-sized toilet. For example, U.S. Pat. No. 201,615,212,509 to Edwards et al., on Sep. 27, 2016 provides a means for adjusting the height of their preexisting footstool. This prior art serves as an adjustment to the footstool designed to raise the height of the preexisting stool. Although the height of the adaptation may serve to fit even with a child's potty if used independent of Edwards' footstool, the dimensions are designed to accompany the preexisting adult-sized version. Therefore, as the prior art is designed to be constructed of plastic, the width of the feet placement will be too far apart, and lacking in adjustability, as this invention is designed to accompany the adult-sized version geared towards western style toilets. Further, as this prior art is designed to serve as an adjustment in height to the preexisting footstool, this invention will not allow for independent operation with a child's potty as it has provided no means to secure to the restroom floor preventing slippage while in use.

Several prior art inventions are known for their ability to provide an adjustable footstool when using a western style, adult-sized toilet. For example, U.S. Pat. No. 20,189,895,036 to Edwards et al., on Feb. 20, 2018 provides a means for adjusting the height of a footstool. This prior art is equipped with four adjustable legs attached to the bottom of a rigid platform, and even an option for two handles. However, this device requires strength and dexterity to lock the legs into the proper height, that of which a toddler has still yet to develop. Further, the adjustable legs create a hazard as the child may not adjust the legs to the proper height, thus creating the opportunity for the invention to slip from underneath the child's feet, potentially falling from the potty. This would further discourage the use of a stool with the child while sitting on the toilet, could be extremely messing, and is incredibly hazardous to the well-being of the child. Even if this prior art could be adjusted to the height of a child's potty, the rigid design still would create an uncomfortable feeling in the child while using the potty, as she or he must place their feet on a cold, hardened surface that could be dangerous to handle if left to their own whims and innocence.

Several prior art inventions are known for their ability to provide a pillow or cushion to assist infants and toddlers with posture. For example, U.S. Pat. No. 20,006,079,067 to Becker et al., on Jun. 27, 2000 provides a means for infants and toddlers to learn to sit up without the fear of suffocation. However, this invention is geared towards teaching infants and toddlers to lie face down, sit up, and lay backwards while encompassing a safe breathing posture. This prior art is designed to encompass the infant or toddler within the parameters of this design. It is not developed to serve as a footrest to encourage a squatting position for toddlers and small children to use a children's potty.

Several prior art inventions are known for their ability to provide a pillow or cushion to support the human body. For example, U.S. Pat. No. 20,050,144,725 to Guarino on Jul. 7, 2005 provides a means for supporting the human body. However, this pillow is designed to provide comfort to, and or alleviate stress and or joint pain from the individual while lying horizontally during a period of rest.

Several prior art inventions are known for their ability to provide a pillow or cushion to support the human body in a multitude of positions. For example, U.S. Pat. No. 20,056,925,669 to Friedman et al., on Aug. 9, 2005 provides a means for supporting the human body by allowing for interlocking pillows made of the same material to be arranged in a variety of configurations. However, this prior art invention is geared more towards adults as it is designed to serve as a substitute for furniture, therapeutic joint pain alleviation, and or a device to aid in the enhancement of sexual positions during intercourse. The large and bulky nature of this prior art is unnecessary and obtrusive to serving as a footrest for toddlers and children using a children's potty.

There have been stools and foot rests that attempt to resolve the problem of placing one's feet into an elevated position to encourage the squatting posture while sitting on a toilet and defecating. However, these prior art inventions are constructed of a hardened material, such as plastic or wood, and designed to accommodate an adult-sized, Western-style toilet. The cold and plain nature of this prior art serves as a deterrent to being utilized by a toddler and or child while using a child's potty. Further, the prior art, when attempting to accommodate the variance in height of its user, is usually only compatible with other versions produced by the same manufacturer and or company. When prior art has attempted to produce a stool that would fit all shapes and sizes, it is still bulky, made of a hardened material, plain, and fails to meet the incremental height and width size requirements of a toddler or child using a children's potty. Further, the prior art fails to provide a means for engaging the toddler or child's senses and intellect while encouraging her or him to use a stool to form and utilize the squatting position while leaning to defecate into a potty. The prior art fails in every way to create a fun and personalized experience for the toddler or child learning to squat while using the potty to expel excrement.

One embodiment of the invention includes a padded 52 and or inflatable 51 cushion 48 system that is compatible with a toddler and or child's sized potty to serve as a means to encourage the toddler or child into the squatting position while defecating into her or his potty. This padded 52 and or inflatable 51 cushion system 48 also serves to instruct, educate, inspire, engage, and encourage the toddler and or child in her or his biopsychosocial and emotional development. The padded 52 and or inflatable 51 cushion 48 system is designed to appeal to the toddler or child's cognitive development and sensory play. The padded 52 and or inflatable 51 cushion system 48 can be designed as a character, individual, mode of transportation, and or animal. The padded 52 and or inflatable 51 cushion 48 system is lightweight, soft, and colorful. The padded 52 and or inflatable 51 cushion 48 system can produce sounds, scents, vibrations, and, but not limited to, lights when engaged by the toddler, child, and or caregiver. The cushion 48 system can be placed flat or at an angle in front of a toddler or child's sized potty. The cushion 48 system is secured to the floor or another surface using suction cups 40. The cushion system 48 has foot placements 22 included on the top of the cushion 48, informing the toddler or child where to place her or his feet to engage in a squatting position while sitting on the potty and defecating. The cushion 48 system can be quickly and easily attached and detached to nearly any surface. The padded 52 and or inflatable 51 cushion system 48 is lightweight, compact, safe, and convenient for traveling outside the home. The padded 52 and or inflatable 51 cushion 48 system can be stored in drawers, bags, closets, or any variety of locations around the home that make it inconspicuous and out of the way when not in use. The padded 52 and or inflatable 51 cushion system 48 provides a convenient, efficient and expedient means for cleaning and drying the cushion system 48 when needed. The padded 52 and or inflatable 51 cushion 48 system provides a convenient means to personalize 27 the cushion 48 and alter the educational 26, instructional 25, and or encouraging 24 material as the toddler or child develop, and or as often as desired by the caretaker. The padded 52 and or inflatable 51 cushion 48 system is available in a variety of shapes, sizes, and materials to accommodate any sized toddler or child using a potty, or ready for the adult-sized toilet. The padded 52 and or inflatable 51 cushion system 48 is compatible with nearly any floor, stool 49, and or footrest. The padded 52 and or inflatable 51 cushion system 48 is compatible with Wi-Fi, Bluetooth, the internet, and computer programs and applications. The compact design allows for brick and mortar sales as it requires little square footage to store a large quantity.

The cushion system 48 satisfies these objects and thus facilitates the use of my improved method of supporting toddlers and or children in squatting while defecating into a toddler or child-sized potty. The users will enjoy the benefits of an increased ease when defecating. The users will further enhance their physiological function by engaging in the squatting position while releasing a bowel movement from a young age, thus transitioning to the adult-sized toilet prepared to continue the squatting position for their lifetime while defecating. Thus, there will be no need for the child to relearn how to defecate once developing to a size requiring the use of an adult-sized toilet. This will further encourage and enhance a healthy intestinal track and lifestyle for the user by squatting while defecating. The potty pad system provides a means to educate, engage, instruct, and inspire toddlers and children while using the potty to defecate. The potty pad system will also enhance the caregiver, child relationship while providing a means to ease the frustrations that can occur for all parties involved while potty training a toddler. This potty pad system will further inspire a positive self-image for the user. This potty pad system will enhance the toddler's cognitive development by providing an entertaining and engaging means to reach the child while she or he is sitting for a duration of time on a potty attempting to learn to defecate in said container. The opportunity to engage the child in a positive and educational manner will further strengthen the caregiver toddler relationship, while encouraging a lifetime of enjoyment while learning. Further, the potty pad system will provide users a greater savings of resources such as time, money, and space as this device provides a consolidation of features, including, but not limited to, an educational, instructional, and inspiring platform that is also easy to clean, store, and, but not limited to, transport. The potty pad system will also reduce potential harmful bacterial colonization and infection to the device, its surrounding area, and most importantly to its user.

The potty pad system offers a novel solution to the major problems surrounding the proper squatting posture for toddlers and children learning to use a child-sized potty to release a bowel movement, while providing an easy and convenient means to instruct, educate, engage, and inspire the toddler or child while she or he is learning to defecate into a potty.

### Advantages

This invention holds several advantages over the prior art. The potty pad system can be designed to fit sleekly in cupboards, drawers, closets, bags, and or other spaces in or outside of the house. It can be quickly and conveniently attached and detached to nearly any floor or surface on, near, and or around a child-sized potty, or adult-sized toilet. The invention can secure safely and conveniently to nearly any floor or surface with suction cups. The invention can inflate and deflate for convenient travel and or storage. This invention can engage and or enhance the toddler and or child's cognitive development and sensory play though sight, touch, smell, and, but not limited to, sound. The potty pad system can contain instructional, educational, and or inspiring material to further enhance the toddler or child's cognitive development, as well as her or his physiological, emotional, social, and but not limited to, psychological well-being. This invention can be personalized and the material placed upon it altered to the toddler, child, and or caregiver's preference as often as desired. This invention is easily washable and safe for use with washing and or drying machines. This can further protect user health. The potty pad can be designed as a character, individual, mode of transportation, and or animal producing a fun and engaging atmosphere for the toddler to learn to squat while defecating into the potty. Apprehension and dread for potty training can be reduced and or avoided by using this soft, engaging, and child friendly invention.

### BRIEF DESCRIPTION OF THE DRAWINGS

In the drawings, closely related figures have the same number but different alphabetic suffixes. It is understood that the figures are for illustration purposes. They are not to scale, and are not intended to limit the scope of the invention.

FIG. 1A depicts a top view of the potty pad system closed.

FIG. 1B depicts a bottom view of the potty pad system.

FIG. 1C depicts a top view of the potty pad system open exposing the inside padding.

FIG. 2A depicts a top view of the system with an inflatable nozzle.

FIG. 2B depicts a bottom view of the system with an inflatable nozzle.

FIG. 2C depicts the extremities of the cushion folded in and the carry strap in the engaged position.

FIG. 3 depicts a front view cushion attached to a stool or footrest.

FIG. 4A depicts a front view of a device that secures to a wall near a toilet or potty and is in the closed position.

FIG. 4B depicts an angled side view of a device that secures to a wall near a toilet or potty and is in the open position.

FIG. 4C depicts a back view of a device that secures to a wall near a toilet or potty and is in the open position.

FIG. 4D depicts a back view of a portion of a device that secures to a wall

### DRAWINGS—REFERENCE NUMERALS

22 Allocated foot placement
23 Directional information for foot placement
24 Positive affirmation
25 Instructional and or health enhancing message
26 Educational information
27 Personalized name of child
28 Pull tab and slider of zipper
29 Zipper
30 Interior space to hold filler and or padding
31 Eyebrows to character, individual, mode of transportation, and or animal's face
32 Eyelashes to character, individual, mode of transportation, and or animal's eyes
33 Eyeball to character, individual, mode of transportation, and or animal's face
34 Pupil to character, individual, mode of transportation, and or animal's eyes
35 Nose and or nostrils to character, individual, mode of transportation, and or animal's face
36 Mouth and or teeth to character, individual, mode of transportation, and or animal's face
37 Arms and or hands to character, individual, mode of transportation, and or animal's body
38 Ears to character, individual, mode of transportation, and or animal's face
39 Inside canals to ears to character, individual, mode of transportation, and or animal's face
40 Suction cups
41 Clips and or ties
42 Base that secures to the wall
43 Adjustable track teeth
44 Hinges
45 Platform for feet and or cushion and feet
46 Screw holes
47 Track system
48 Attachable and detachable potty pad cushion system
49 Top of standard stool used for adult toilets
50 Leg to stool
51 Inflatable nozzle
52 Sound, light, vibration, and or scent production
53 Padding and or inflatable material inside cushion
54 Opening to inside of cushion
55 Tuck away and carry strap or handle

### DETAILED DESCRIPTION

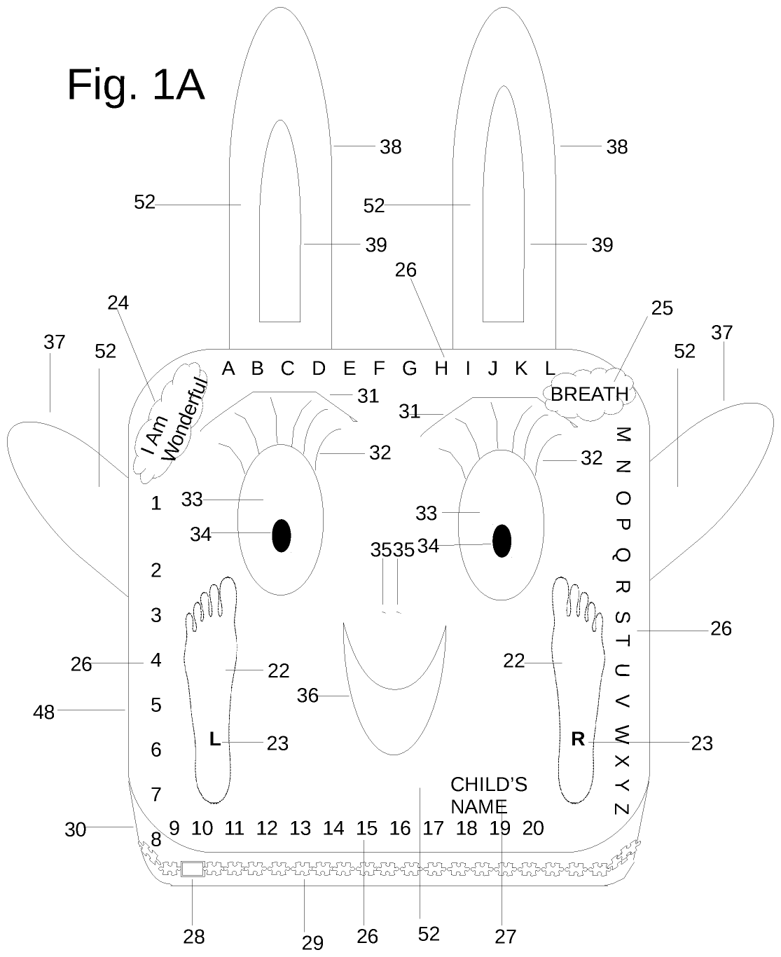

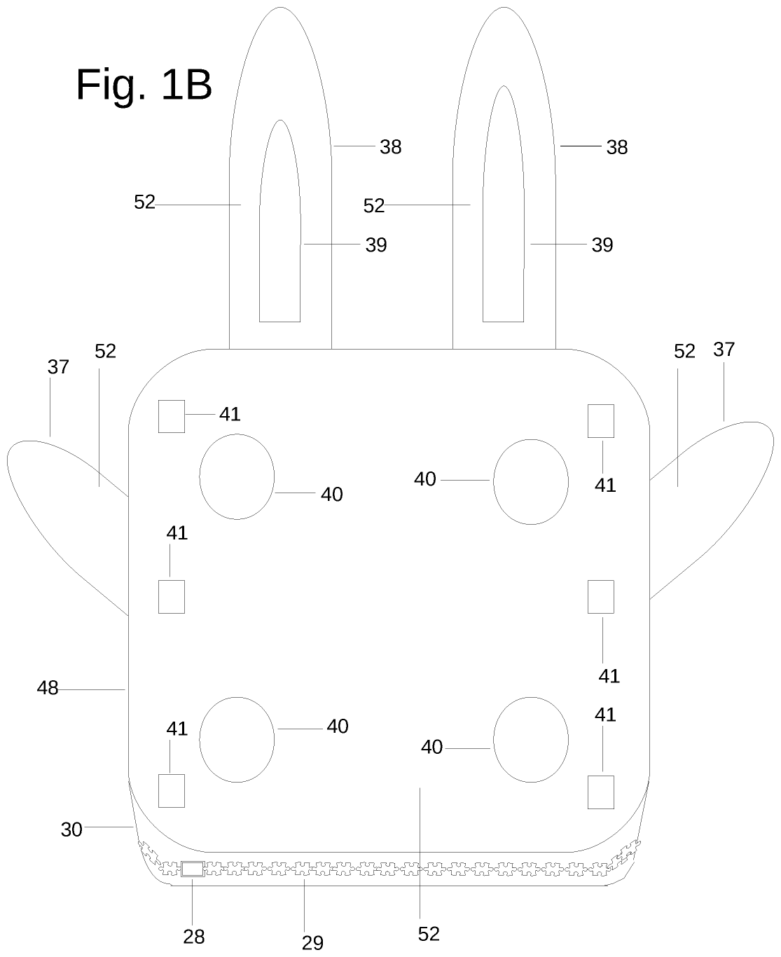

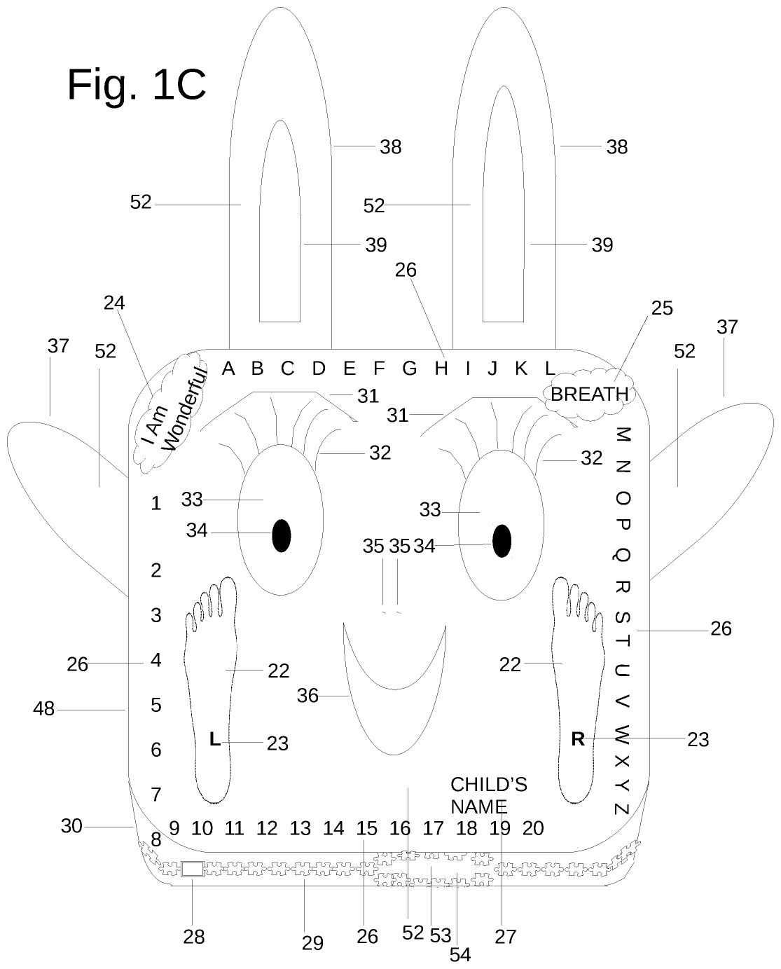

### FIGS. 1-3

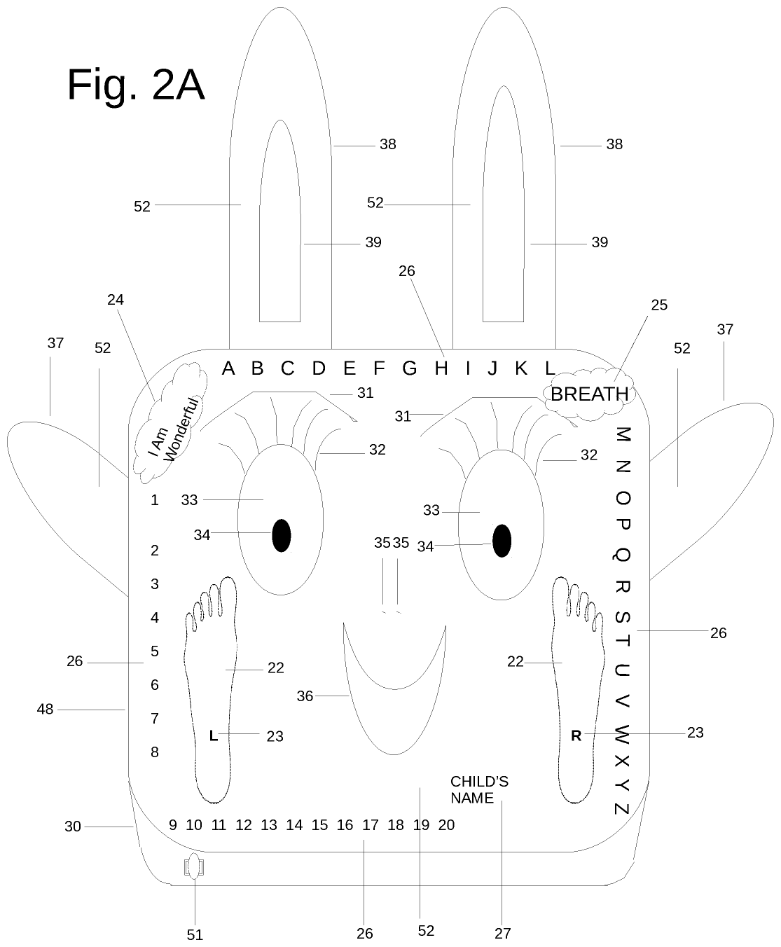

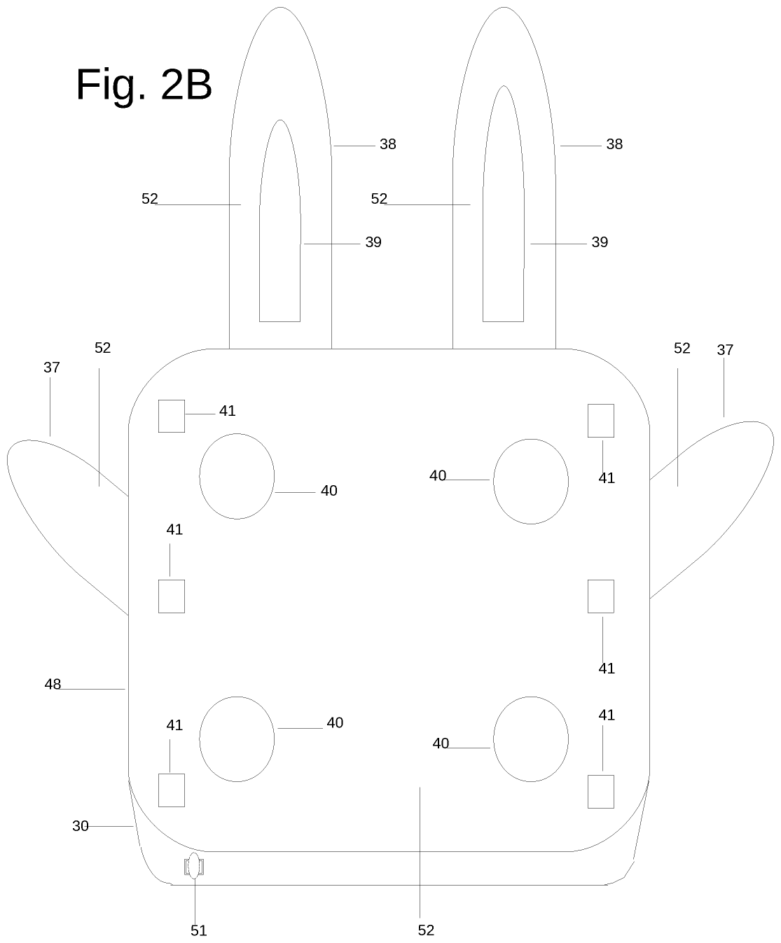

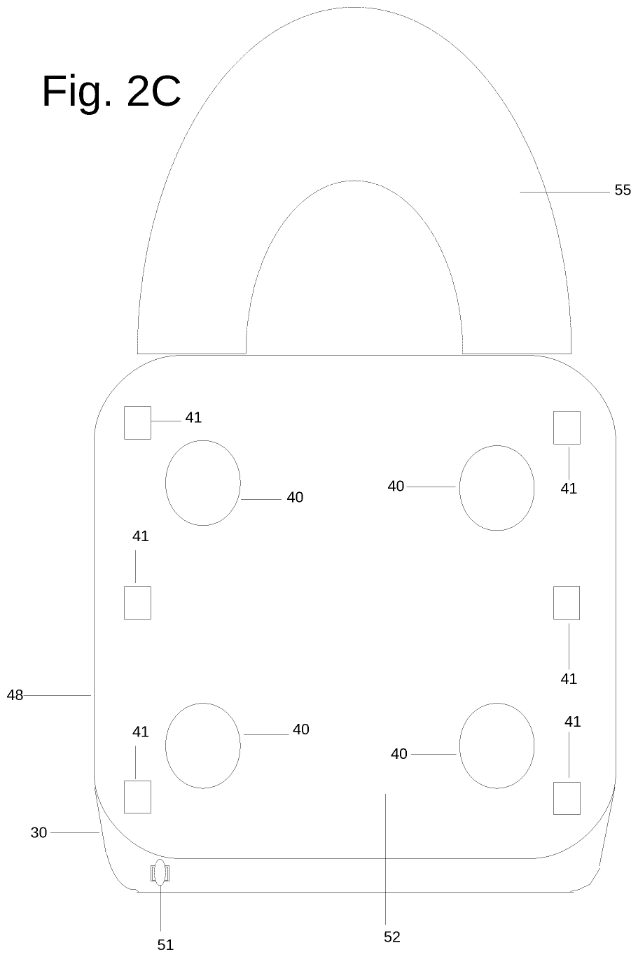

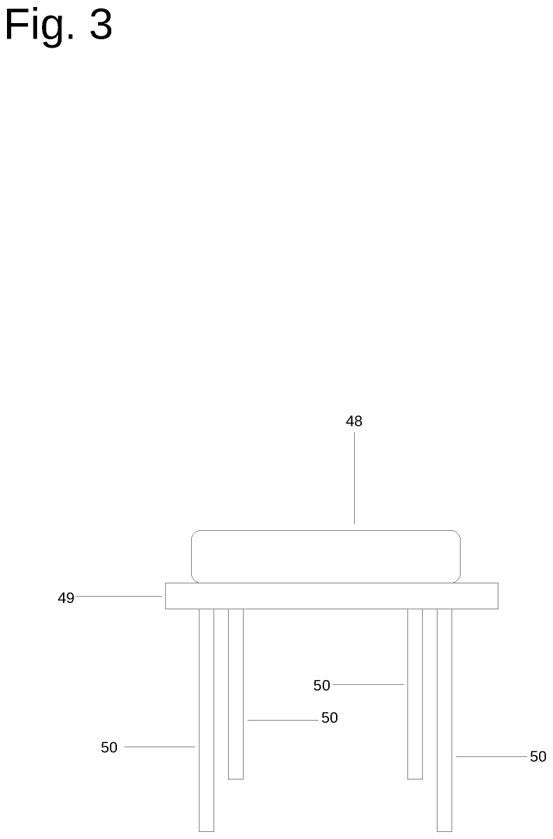

Embodiments of the potty pad system are illustrated in FIGS. 1A, 1C, and 2A (top view), FIGS. 1B, 2B, 2C (bottom view), and FIG. 3 (front view). This device can comprise an attachable and detachable cushion system 48. The cushion system 48 can have a top, sides, and a base with or without legs consisting of a flexible, washable, durable material which can securely house padding and or inflatable material 53 without compromise to its structure due to the force generated by the pressure of a toddler and or child placing her or his feet on any portion of the device. For example, the top, sides, and base of the cushion system 48 and padding and or inflatable material 53 can be composed of, but not limited to, natural or synthetic fibers and can include cotton, mesh, micro fiber terry cloth, nylon, nylon ripstop, rayon, linen, polyester, polyethylene, leather, vinyl, combinations thereof, or the like. The cushion system 48 and padding and or inflatable material 53 can consist of any other material, and or combination of materials, that can be repeatedly compressed, opened, and exposed to force generated from compression and or cleaning without tear or fracture, such as steel, aluminum, acrylonitrile butadiene styrene, thermoplastic, foam, thermoplastic elastomers, silicone, vinyl, nylon, mesh, high-density polyethylene, polyethylene terephthalate, polyvinyl chloride, low-density polyethylene, polypropylene, polycarbonate, polylactide, any other plastic, microfiber, composite, and the like. The cushion system 48 and padding and or inflatable material 53 can be designed as a character, individual, mode of transportation, and or, but not limited to, an animal's face (FIGS. 1A, 1C, and 2A). The character, individual, mode of transportation, and or, but not limited to, animal's face can include any, all, but not limited to, of the following: eyebrows 31, eyelashes 32, eyeballs 33, pupils 34, nose or nostrils 35, mouth 36, inside canals 39, arms and or hands 37, ears 38, legs, feet, teeth, a tail, claws, knees, elbows, shoulders, tires, wings, headlights, steering wheel, door, et cetera. The following, but not limited to, design items: eyebrows 31, eyelashes 32, eyeballs 33, pupils 34, nose or nostrils 35, mouth 36, arms and or hands 37, ears 38, legs, feet, teeth, a tail, claws, knees, elbows, shoulders, tires, wings, headlights, steering wheel, door, etc. can be of any size, shape, number, sequence, form, and or design. For example, the cushion system 48 and padding and or inflatable material 53 can be between 0.05 and 610 cm in length, between 0.05 and 305 cm in width, and between 0.05 and 244 cm in height. For example, the preferred range for the cushion system 48 and padding and or inflatable material 53 can be between 20 cm and 122 cm in length, between 20 cm and 122 cm in width, and between 1 cm and 122 cm in height. For example, the cushion system 48 and padding and or inflatable material 53 can be 50.8 cm in length, 50.8 cm in width, and 7.62 cm in height. The cushion system 48 can have an opening 54 can include a zipper 29, buttons, and or any other appropriate method of hook, loop and fasten. The cushion opening 54 can be of any size, shape, order, and number of openings. For example, the cushion opening 54 can be between 0.05 and 610 cm in length, between 0.05 and 305 cm in width, and between 0.05 and 244 cm in height. For example, the preferred range for the cushion opening 54 can be between 0.05 cm and 122 cm in length, between 0.05 cm and 122 cm in width, and between 0.05 cm and 92 cm in height. For example, the cushion opening 54 can be 50.8 cm in length, 50.8 cm in width, and 7.62 cm in height. There can be 1, 2, 3 or more cushion openings. The cushion storage space 30 can be large enough to fit padding, diapers, shoes, cleaning supplies, and but not limited to, inflatable material inside the cushion system 48 (FIGS. 1A, 1B, 1C, 2A, 2B, and 3). The cushion storage space 30 can be large enough and flexible enough to fit padding, inflatable materials, garments and or accessories in any other appropriate manner securely inside the cushion system 48.

The cushion system 48 can have a strap or handle 55 (FIG. 2C) be composed of, but not limited to, natural or synthetic fibers and can include cotton, mesh, micro fiber terry cloth, nylon, nylon ripstop, rayon, linen, polyester, polyethylene, leather, vinyl, combinations thereof, or the like. For example, the strap or handle 55 can be between 0.05 and 610 cm in length, between 0.05 and 305 cm in width, and between 0.05 and 244 cm in height. For example, the preferred range for the strap or handle 55 can be between 20 cm and 122 cm in length, between 20 cm and 122 cm in width, and between 1 cm and 122 cm in height. For example, the strap or handle 55 can be 92 cm in length, 5.08 cm in width, and 1.27 cm in height. The strap or handle 55 can secure and or be stored to any portion of the cushion system 48 by attaching it directly to the cushion system 48 and or inside a pocket or pouch enclosed by a zipper, button, and or any other appropriate method of hook, loop and fasten.

The attachable and detachable cushion system 48 can be secured to nearly any floor or surface with suction cups 40, clips and or ties 41, magnets, hooks, loops and fastens, and or, but not limited to, adhesives, or the like (FIGS. 1B, 2B, and 2C). The suction cups 40, clips and or ties 41, and or hooks, loops, fastens, and or magnets, and or adhesives can be composed of vinyl, urethane, high-density polyethylene, polyethylene terephthalate, polyvinyl chloride, low-density polyethylene, polypropylene, polycarbonate, polylactide, iron, cobalt, nickel, brass, steel, aluminum, and any other plastic, rubber, metal, composite, and the like. The suction cups 40, clips and or ties 41, and or hooks and or magnets, and or adhesives can be attached, and or detached, to any portion of the cushion system 48 by hook, loop and fasten, sewn, and or any other appropriate manner. For instance, the suction cups 40, clips and or ties 41, and or hooks, loops and fastens, and or magnets, and or adhesives can be attached to the base of the cushion system 48. The suction cups 40 and or hooks, loops and fasten, and or magnets and or clips and or ties 41 can be between 0.05 and 610 cm in length, between 0.05 and 305 cm in width, and between 0.05 and 244 cm in height. For example, the preferred range for the suction cups 40 and hooks, loops and fasten, and clips and or ties 41 can be between 1 cm and 183 cm in length, between 0.05 cm and 46 cm in width, and between 1 cm and 92 cm in height. The suction cups 40 and or hooks, loops and fasten, and or magnets and or clips and or ties 41 can be 3.81 cm in length, 3.81 cm in width, 7.62 cm in height, and 0.127 cm in thickness.

The attachable and detachable cushion system 48 can contain allocated foot placements 22 and directional information for foot placements 23. The allocated foot placements 22 and directional information for foot placements 23 can be permanently secured to, or attach and detach, from the cushion system 48 (FIGS. 1A, 1C, and 2A). The allocated foot placements 22 and directional information for foot placements 23 can attach and detach to any portion of the cushion system 48 by hook, loop and fasten, zipper, button, or any other appropriate method. The allocated foot placements 22 and directional information for foot placements 23 can be composed of vinyl, urethane, high-density polyethylene, polyethylene terephthalate, polyvinyl chloride, low-density polyethylene, polypropylene, polycarbonate, polylactide, cotton, mesh, nylon, rayon, micro fiber terry cloth, polyester, vinyl, linen, iron, cobalt, nickel, brass, steel, aluminum, and any other plastic, rubber, metal, composite, and the like. The allocated foot placements 22 and directional information for foot placements 23 can be between 0.05 and 610 cm in length, between 0.05 and 305 cm in width, and between 0.05 and 244 cm in height. For example, the preferred range for the allocated foot placements 22 and directional information for foot placements 23 can be between 1 cm and 122 cm in length, between 0.05 cm and 80 cm in width, and between 1 cm and 92 cm in height. The allocated foot placements 22 and directional information for foot placements 23 can be 17.78 cm in length, 10.16 cm in width, 1.27 cm in height, and 0.127 cm in thickness.

The positive affirmation 24, instructional and or health enhancing message 25, educational information 26, and personalized name of the child 27 can be permanently secured to, or attach and detach from, the cushion system 48. The positive affirmations 24 can appear in or on any portion of the cushion system 48, and in any size, shape, number, sequence, form, and or design. For instance, the positive affirmation 24 could appear in a bubble or cloud with a message such as, but not limited to, “I am wonderful” (FIGS. 1A, 1C, and 2A). The instructional and or health enhancing message 25 can be of any size, shape, number, order, and form. For instance, instructional and or health enhancing message 25 could appear in a bubble or a cloud with a message such as “breathe” (FIGS. 1A, 1C, and 2A). The educational information 26 can be of any size, shape, number, order, and form. For instance, educational information 26 could appear along the outer edges of the cushion system 48 as words, puzzles, the alphabet, numbers, colors, games, questions, and, but not limited to, mathematics (FIGS. 1A, 1C, and 2A). The personalized name of the child 27 can be of any size, shape, number, order, and form. For instance, the personalized name of the child 27 could appear in the center of the cushion system 48 (FIGS. 1A, 1C, and 2A). The positive affirmation 24, instructional and or health enhancing message 25, educational information 26, and personalized name of the child 27 can be between 0.05 and 610 cm in length, between 0.05 and 305 cm in width, and between 0.05 and 244 cm in height. For example, the preferred range for the positive affirmation 24, instructional and or health enhancing message 25, educational information 26, and personalized name of the child 27 can be between 1 cm and 122 cm in length, between 0.05 cm and 80 cm in width, and between 1 cm and 92 cm in height. The positive affirmation 24, instructional and or health enhancing message 25, educational information 26, and personalized name of the child 27 can be 7.62 cm in length, 3.81 cm in width, and 7.62 cm in height.

Any part of the cushion system 48, including, but not limited to, the cushion, eyebrows 31, eyelashes 32, eyeballs 33, pupils 34, nose or nostrils 35, mouth 36, inside canals 39, arms and or hands 37, ears 38, legs, feet, teeth, a tail, claws, knees, elbows, shoulders, tires, wings, headlights, steering wheel, door, etc. can emit a sound, light, vibration, and or scent 52 when engaged by the user. Engagement which leads to activation of a sound, light, and or scent 52 can include, but is not limited to, any the following methods: pulling, pushing, squeezing, hitting, twirling, voice recognition, and or shaking. The pulling, pushing, and or, but not limited to, squeezing can even serve to assist the toddler or child in bearing down while attempting to force feces from her or his bowels and into the potty. The sound 52 can be of any frequency, range, decibel, and or, but not limited to, rhythm. The light 52 can be of any color, consistency, vibrance and or wavelength on the electromagnetic spectrum. The scent 52 can be of any molecular shape, size, and or structure distinguishable and or indistinguishable to the human olfaction system.

In some embodiments, the cushion system 48 can be formed in various compact, collapsible and mobile shapes (For example in FIG. 2C). FIGS. 2A, 2B, and 2C also show the inflatable nature of the design. Any shape or combination of shapes can be considered part of the padded and or inflatable design of the cushion system 48. For example, the container can be rectangular, circular, or the shape of a character, individual, mode of transportation, animal, and or the like. The container system 48 can have a heating and or cooling mechanism included on the top, sides, and or bottom of the cushion system 48 designed to alter the temperature of the user's feet, and therefore body, to encourage further comfort while defecating into a toddler or child's potty. The heating and or cooling mechanism can be between 0.05 and 610 cm in length, between 0.05 and 305 cm in width, and between 0.05 and 244 cm in height. For example, the preferred range for the heating and or cooling mechanism can be between 1 cm and 183 cm in length, between 0.05 cm and 46 cm in width, and between 1 cm and 92 cm in height. The heating and or cooling mechanism can be 3.81 cm in length, 3.81 cm in width, 7.62 in height, and 0.127 cm in thickness. The cushion system 48 can also be included with a toddler or child-sized potty. The cushion system 48 can be customizable and interchangeable in its aesthetic design while maintaining its purpose of encouraging the toddler or child to squat while defecating. The customizable nature of the cushion system 48 allows for the child to adapt this to any preexisting, and or included, footrests or stools 49 designed for an adult-sized toilet (FIG. 3).

### Methods

The manner to place the cushion system 48 in front of a toddler or child-sized potty can be performed by ensuring the cushion system 48 is first unfolded and placed on, but not limited to, a semi flat space. The cushion system 48 can then be personalized to the child and or caregiver's liking with positive affirmations 24, instructional and or health enhancing information 25, educational information 26, and or the personalized name of the child 27 by placing the precut material onto any portion of the cushion system 48 in any number, shape, order, and or design by use of a hook, loop and fasten system and or in any other appropriate manner. With the entire cushion system 48 personalized to the user's preference, the cushion system 48 can be inflated by forcing air by use of a pump, the user blowing into the inflatable nozzle 51, and or any other appropriate manner. Once the cushion system 48 is at the desired height and or degree of elevation for the toddler or child it can be secured to the floor in front of the toddler and or child-sized potty by engaging the suction cups 40 sewn into the bottom portion of the fabric of the cushion system 48. The suction cups 40 can be secured to the floor or another surface in front of the toddler or child-sized potty by pressing the suction cup or cups 40 firmly in place making sure there are no air bubbles between the suction cup(s) 40 and the mounting surface. The toddler and or child then mounts the potty sitting onto the open seat in preparation to defecate into the designated potty. The toddler and or child then places her or his feet onto the allocated foot placements 22 and is then instructed by the parent as to the correct positioning of the toddler or child's feet by engaging the toddler or child to the directional information for foot placement 23 on the cushion system 48. Once the toddler or child's feet are in the correct foot placement 22 on the cushion system 48, this will force the toddler or child's feet to be raised from the floor or any other appropriate surface, lifting her or his knees and or thighs above the toddler or child-sized potty and forcing the toddler or child to utilize a squatting position. The toddler or child's legs will be elevated at the degree or angle chosen by the user when securing the cushion system 48 to the floor. While the toddler or child is sitting with her or his feet on the cushion system 48 in the correct placement and in the squatting position while waiting, attempting, or defecating into the potty the caregiver can engage the toddler or child with the positive affirmations 24, instructional and or health enhancing information 25, educational information 26, and or the personalized name of the child 27. This can involve asking the toddler or child questions related to the positive affirmations 24, instructional and or health enhancing information 25, educational information 26, and or the personalized name of the child 27 to encourage cognitive development and or sensory play. The toddler or child may further interact with the cushion system 48 and its, but not limited to, eyebrows 31, eyelashes 32, eyeballs 33, pupils 34, nose or nostrils 35, mouth 36, inside canals 39, arms and or hands 37, ears 38, legs, feet, teeth, a tail, claws, knees, elbows, shoulders, tires, wings, headlights, steering wheel, door, etc. by any the following, but not limited methods: pulling, pushing, squeezing, hitting, twirling, voice recognition, and or shaking. The material objects serving as a holding, pulling, and or pushing device can create sounds 52, music 52, vibration 52, scents 52, and or, but not limited to, lighting 52 effects when engaged. When the toddler or child has finished defecating into the potty and has completely and properly cleaned her or himself, she or he may exit the potty and cushion system 48 by removing her or his feet from the allocated foot placements 22 and placing them on the floor and or another appropriate surface. The cushion system 48 may also be removed from the area by releasing the holding pressure between the floor and the suction cups 40 by lifting the edge of the suction cups 40 and releasing the pressurized force inside the suction cups and holding the cushion system 48 in place. The cushion system 48 can then be deflated by releasing air from the inflatable nozzle 51 and folded and placed into an accompanying carry bag. The cushion system 48 can be removed from the area by carrying it in one's hands and or arms, or by engaging the strap or handle 55 from pouch on the cushion system 48 and placing it in and or on one's hand, hands, shoulder, shoulders, and or any other appropriate body part or manner to lift the cushion system 48 from the floor and transport it from the area. When the cushion system 48 is desired to, or in need of, a cleaning, the outside cover can be removed by moving the slider 28 of the zipper 29 into the open 54 position. The outside cover to the cushion system 48, once freed from electronics, and or padding and or inflatable material 53 and or positive affirmations 24, instructional and or health enhancing information 25, educational information 26, and or the personalized name of the child 27 can then washed by hand and or placed safely into a washing machine and included with any other load of laundry garments, such as towels, clothes, and or, but not limited to, sheets. The padding and or inflatable material 53 can then be placed back inside the outside cover to the cushion system 48 and secured inside by moving the slider 28 of the zipper 29 to the closed position. The electronic equipment can then be placed by back inside the outside cover of the cushion system 48. The positive affirmations 24, instructional and or health enhancing information 25, educational information 26, and or the personalized name of the child 27 can then be customized and placed in any order and on any portion of the cushion system 48.

When the toddler or child has developed in size, confidence, and or dexterity and is ready to use an adult-sized toilet, the cushion system 48 can attach to the top of nearly any preexisting footstool 49 by securing the suction cups 40, clips and or ties 41, and or any other appropriate manner, to the top of the stool 49 and or legs 50 of the stool. The cushion system 48 can be removed from the top 49 and or legs 50 of the stool by releasing the suction cups 40, clips and or ties 41, and or any other appropriate manner that was used to secure the cushion system 48 to the top 49 or legs 50 of the stool.

### Advantages

From the description above, a number of advantages of some embodiments of my attachable and detachable potty pad cushion system become evident:

(a) A cushion system that encourages toddlers and or children to squat while defecating to enhance physical well-being that is adaptable to a toddler or child-sized potty.

(b) A cushion system that serves to engage, encourage, enhance, instruct, entertain, and educate a toddler or child while learning to squat while defecating into a child-sized potty during potty training.

(c) A cushion system that will enhance the cognitive and biopsychosocial development through sensory play of the toddler or child while being potty trained.

(d) A cushion system that will enhance the parent toddler relationship by providing a means to engage, encourage, enhance, instruct, entertain, and educate the toddler and or child by minimizing the pains, pressures, and stresses associated with potty training for all parties involved.

(e) A cushion system that is customizable and easy to hand and or machine wash.

(f) A cushion system that is lightweight, durable, and easy to attach, detach, store, and transport.

(g) A cushion system that is adaptable to preexisting footstools of all shapes, sizes, and styles.

(h) A cushion system that is soft and comfortable for the toddler or child to rest her or his feet on while learning to, and defecating into a potty while engaged in the squatting position.

### EXAMPLES

The following non-limiting examples are provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

### Example 1

### Age of Use

The attachable and detachable padded and or inflatable potty pad cushion system is geared towards toddlers and or children beginning the first stage of potty training until the age the child decides she or he no longer would like to use the cushion system to engage in the squatting position while defecating into a toddler-sized potty or adult-sized toilet. However, alternative embodiments may also pertain to teens, adults, and or the elderly.

### Example 2

### Alternatives to Attachable and Detachable Cushion System

Additional embodiments of the invention are shown in FIGS. 2A, 2B, and 2C; in each case the strap and or handle 55 placement, padding and or inflatable material 53, and inflatable nozzle 51 of the cushion system 48 provide examples, but not limitations to the variety of options for design. The cushion system 48 can also be equipped with a monitor, Wi-Fi, and or a Bluetooth connection. The cushion system 48 and its positive affirmation 24, instructional and or health enhancing message 25, educational information 26, and personalized name of the child 27 and sounds 52, scents 52, vibrations 52, and, but not limited to, lights 52 can further be customized and engaged through the internet, a web portal, and or an application, such as an app designed for a smartphone or tablet. The cushion system 48 can also be equipped with any type of surface that permanent and or removable marks may be added to any portion of the outside or inside of the cushion system 48. For instance, a digital art board and or a digital pen located on top of the cushion system 48, a white board for drawing with markers on top of the cushion system 48, a chalk board that slides out from the side of the cushion system 48, blank note pads for coloring, dry erase writing utensils, and but not limited to, permanent and or removable fabric markers, pens, and or paints. The cushion system 48 may also contain a calendar and or any other appropriate system to monitor progress and engage and enhance the child's cognitive development and or motor skills, including, but not limited to, problem solving skills, memory, critical thinking, and or creativity. For example, on Monday the child successfully used the potty twice so received a positive sticker and or any other appropriate demarcation in the permanent and or removable allocated location to celebrate her or his success. Further, the cushion system 48 can even be developed to assist adults, including, but not limited to, the elderly in engaging in the squatting position while defecating into a Western or Eastern adult-sized toilet. The cushion system 48 may be equipped with health and safety monitoring equipment to notify the individual, predetermined parties, and or the proper authorities if the elderly individual needs, or is requesting, personal and or, but not limited to, medical assistance. The cushion system 48 can be designed as artwork, photos, animals, individuals, characters, and or nearly any other personalized design request. The cushion system 48 can include handles, and or any other easily accessible extremities hanging from and or attached to it, to assist the elderly person in bearing down while defecating into the toilet while squatting, and or requesting personal, and or, but not limited to, medical assistance.

### Example 3

### Alternatives to Cushion System

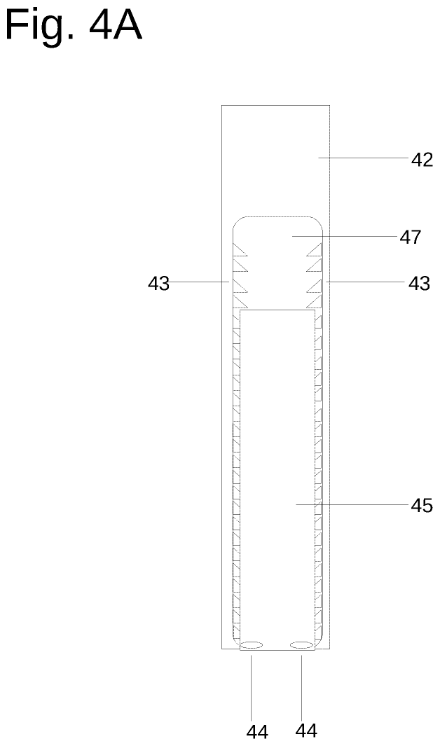

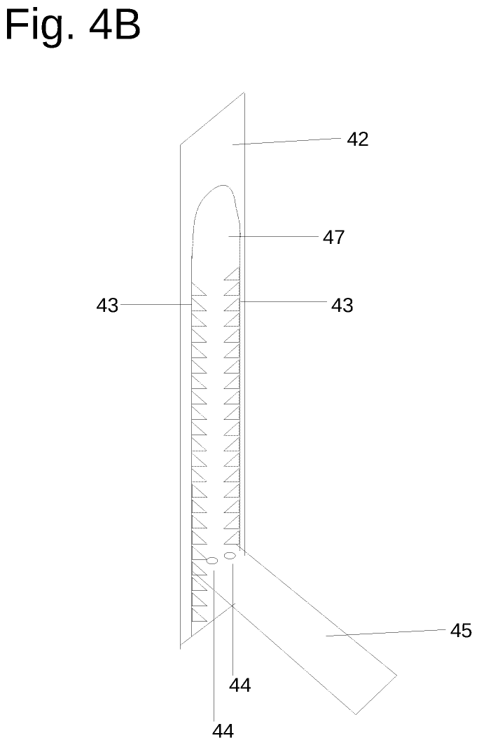

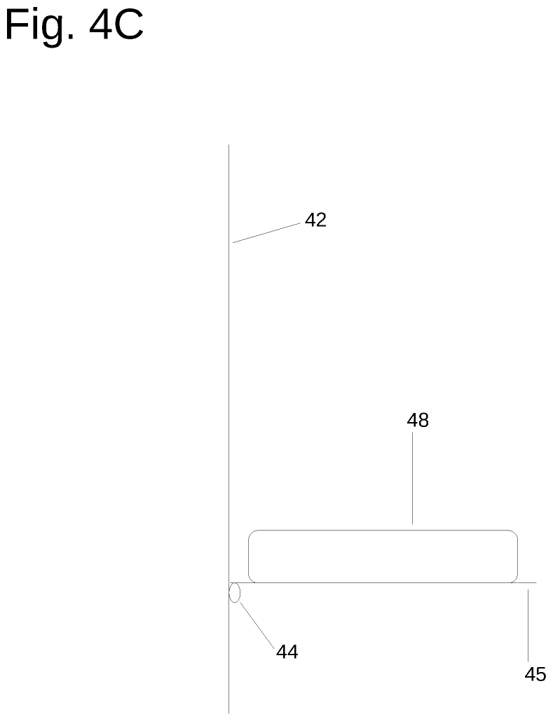

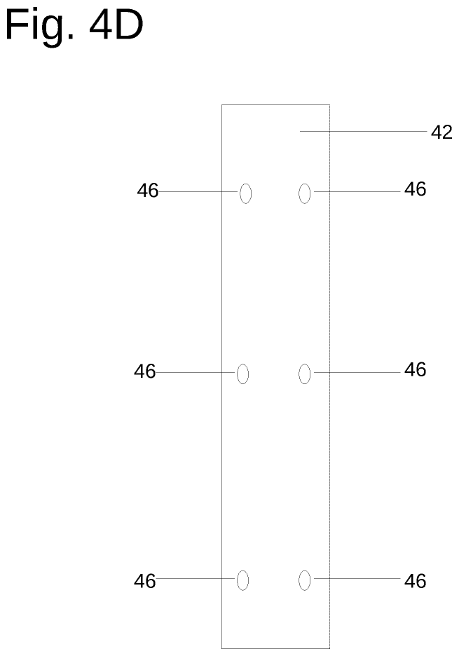

There are various possibilities with regard to the relative design of the cushion system 48 depending upon the selection of material type and location of device. The cushion system 48 may be designed to fold and or unfold in any manner that would further enhance the compactness and or efficiency of the device. FIGS. 4A, 4B, 4C, and 4D shows a cushion system to encourage the squatting position while defecating into a toddler-sized potty and or adult-sized toilet, that attaches to the nearby wall. This can be a compact and foldable device that also allows for the attachment of other accessories, such as, but not limited to, rolls of toilet paper, a trash can, or a toilet brush. This can be a durable, lightweight, plastic and or any other appropriate material with hinges 44, a cushion, a track system 47 to adjust the height of the footrest and or cushion, and, but not limited to, prefabricated screw holes 46 for the device to be secured to a wall or nearby structure that allows for the even distribution of weight between the platform 45 and the portion of the device attached to the wall, stud, and or nearby structure. The cushion system 48 can even be produced as a collapsible, inflatable, and, but not limited to, foldable single unit with a toddler and or child-sized potty.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the invention disclosed herein are illustrative of the principles of the embodiments of the invention. Other modifications that can be employed can be within the scope of the invention. Thus, by way of example, but not of limitation, alternative configurations of the embodiments of the invention can be utilized in accordance with the teachings herein. Accordingly, embodiments of the present invention are not limited to that precisely as shown and described.

What is claimed is:

1. a product comprising any feature described, either individually or in combination with any feature, in any configuration.

2. A system for the entertainment, education, inspiration, instruction, engagement, and the encouragement of the squatting position for toddlers and children when defecating into a child-sized potty or adult-sized toilet,
wherein the cushion system comprises a top portion, side portion, and a bottom portion,
wherein the top portion comprises the customizable and interchangeable material to engage, educate, inspire, instruct, and assist the toddler,
wherein the bottom portion comprises the means to attach the material object,
wherein side portion comprises the means to adjust the height, inflate and or pad the inside of the material object.

3. The system of claim 1 wherein the top portion comprises one or more fastener closure systems to the material object to attach, detach, and interchange the educational, instructional, inspirational, and engaging material to the material object.

4. The system of claim 1 further comprising a removable cushion system that can be cleaned.

5. The system of claim 1 wherein the bottom portion comprises one or more selected from the group of suction cups, magnets, hook, loop and fasten, tape, ties, clips, padding, legs, and or glue.

6. The system of claim 1 where in the side portion comprises an opening and closing allowing access to, and storage of, contents inside the system.

7. The system of claim 1 wherein any portion of the system can emit a sound, scent, vibration, frequency, and or light when engaged by interacting with the system.

8. The system of claim 1 wherein the system has a strap or handle for carrying.

9. The system of claim 1 wherein the device comprises a material selected from the group consisting of high-density polyethylene, polyethylene terephthalate, polyvinyl chloride, low-density polyethylene, polypropylene, polycarbonate, polylactide, cotton, linen, polyester, leather, rubber, fur, velour, denim, satin, mesh, micro fiber terry cloth, canvas, any other natural and or synthetic textile, plastic, nylon, silicone, carbon, composite, and aluminum.

10. The system of claim 1 wherein the system can be secured to the floor or another appropriate mounting surface.

11. The system of claim 1, wherein the system is compressed and stored and transported in a companion, travel container.

12. The system of claim 12 wherein the container is comprised of material selected from the group consisting of high-density polyethylene, polyethylene terephthalate, polyvinyl chloride, low-density polyethylene, polypropylene, polycarbonate, polylactide, cotton, linen, polyester, leather, rubber, fur, velour, denim, satin, mesh, micro fiber terry cloth, canvas, any other natural and or synthetic textile, plastic, nylon, silicone, carbon, composite, and aluminum.

13. A method of educating, inspiring, encouraging, entertaining, engaging, and assisting of a toddler or child to squat while defecating into a toddler-sized potty or adult-sized toilet using the system of claim 1 comprising:
Attaching the system to a floor or mounting surface,
placing the user's feet onto the system,
elevating the knees and legs into the squatting position while defecating,
interacting with the system and or caregiver while feet are placed on the system and
while sitting on the potty or toilet to release a bowel movement.
